(19) United States
(12) Patent Application Publication
(10) Pub. No.: US 2005/0238189 A1
(43) Pub. Date: Oct. 27, 2005

(54) Headphone device with surround sound effect

(75) Inventor: Jonson Tsai, Taipei City (TW)

Correspondence Address: NIXON & VANDERHYE, PC, 901 NORTH GLEBE ROAD, 11TH FLOOR, ARLINGTON, VA, 22203, US

(73) Assignees: GAMMA INC., Taipei City (TW); Pi-Yun HUANG, Taipei City (TW)

(21) Appl. No.: 10/830,057

(22) Filed: Apr. 23, 2004

(51) Int. Cl. H04R 5/00; H04R 5/02

(52) U.S. Cl. 381/309; 381/370

(57) ABSTRACT

A headphone device with surround sound effect has a speaker unit that includes a center channel transducer, a surround channel transducer, a mid/woofer transducer, and a base plate. The base plate has opposite first and second sides. The first side of the base plate is formed integrally with first, second and third transducer coupling portions. Each of the first, second and third transducer coupling portions retains a respective one of the center channel transducer, the surround channel transducer and the mid/woofer transducer on the first side of the base plate such that sound generated by the respective one of the center channel transducer, the surround channel transducer and the mid/woofer transducer radiates through the second side of the base plate. The first, second and third transducer coupling portions have first, second and third axes, respectively. The first, second and third axes extend in mutually different directions.

### BACKGROUND OF THE INVENTION

1. Field of the Invention

The invention relates to a headphone device, more particularly to a headphone device with surround sound effect.

2. Description of the Related Art

Headphone devices are advantageous in that they provide a personalized listening space without disturbing other people. However, in view of their relatively small size, the quality of sound reproduced by most headphone devices is generally inferior to that produced by loudspeakers.

FIG. 9 illustrates a conventional headphone device capable of providing multiple sound channels to achieve an enhanced sound effect. The conventional headphone device has a speaker unit that is connected to a headband 40 and that includes a cap member 45, three sound channel transducers 41, 42, 43, a cover member 44, and a cushion unit 46 mounted on the cover member 44. Each of the sound channel transducers 41, 42, 43 is connected to a respective sound enclosure 47, 48, 49, and is retained in the cap member 45. The sound channel transducers 41, 42, 43 include a front main channel transducer, a center channel transducer, and a rear surround channel transducer. The cover member 44 is disposed to close an open side of the cap member 45, and is formed with three sound hole sets 441, each of which corresponds to a respective one of the sound channel transducers 41, 42, 43.

It is noted that each of the sound enclosures 47, 48, 49 requires a dedicated mold for fabrication, and must be assembled to the respective sound channel transducer 41, 42, 43 before the latter can be positioned between the cap member 45 and the cover member 44. As a result, manufacturing cost of the aforesaid conventional headphone device is relatively high. Moreover, the cap member 45 should be relatively large so as to have sufficient space to accommodate the sound enclosures 47, 48, 49. In addition, mid-range and low-range sound reproduction is relatively poor due to second harmonic distortion attributed to sound-guiding activity of the sound enclosures 47, 48, 49.

### SUMMARY OF THE INVENTION

Therefore, the object of the present invention is to provide a headphone device that can provide a surround sound effect and that can overcome the aforesaid drawbacks of the prior art.

Accordingly, the headphone device with surround sound effect of this invention comprises a speaker unit that includes a center channel transducer, a surround channel transducer, a mid/woofer transducer, and a base plate. The base plate has a first side and a second side opposite to the first side. The first side of the base plate is formed integrally with first, second and third transducer coupling portions. Each of the first, second and third transducer coupling portions retains a respective one of the center channel transducer, the surround channel transducer and the mid/woofer transducer on the first side of the base plate such that sound generated by the respective one of the center channel transducer, the surround channel transducer and the mid/woofer transducer radiates through the second side of the base plate. The first, second and third transducer coupling portions have first, second and third axes, respectively. The first, second and third axes extend in mutually different directions.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled perspective view of the preferred embodiment of a headphone device with surround sound effect according to the present invention;

FIG. 2 is an exploded perspective view of a speaker unit of the preferred embodiment;

FIG. 3 is a fragmentary assembled perspective view of the speaker unit of FIG. 2, viewed from a first side of a base plate of the speaker unit;

FIG. 4 is another fragmentary assembled perspective view of the speaker unit of FIG. 2, viewed from a second side of the base plate of the speaker unit;

FIG. 5 is a schematic view showing the first side of the base plate of the speaker unit;

FIG. 6 is a schematic sectional view taken along line 6-6 of FIG. 5;

FIG. 7 is a schematic sectional view taken along line 7-7 of FIG. 5;

FIG. 8 is a schematic sectional view taken along line 8-8 of FIG. 5; and

FIG. 9 is a fragmentary exploded perspective view of a conventional headphone device.

### DETAILED DESCRIPTION OF THE PREFERRED EMBODIMENT

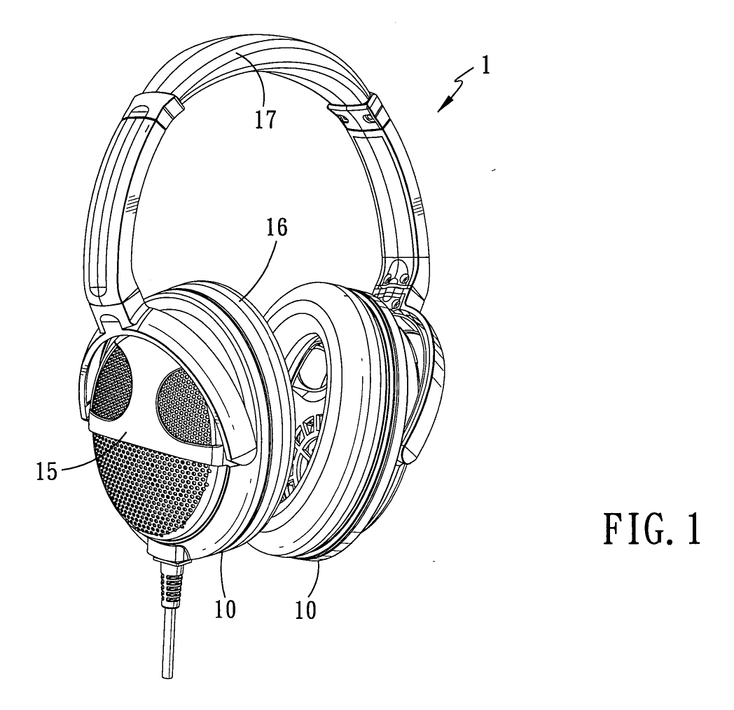

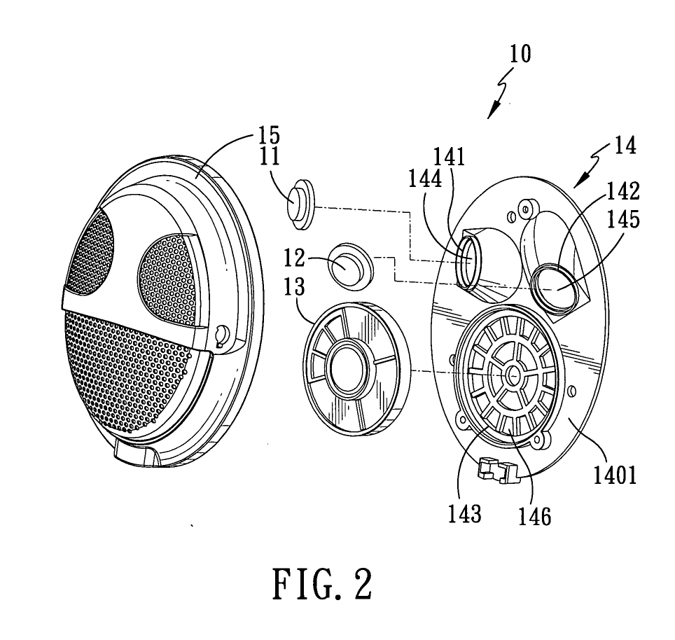

Referring to FIGS. 1 to 4, the preferred embodiment of a headphone device 1 with surround sound effect according to the present invention is shown to include left and right speaker units 10 connected to opposite ends of a headband 17. Each of the speaker units 10 includes a center channel transducer 11, a surround channel transducer 12, a mid/woofer transducer 13, a base plate 14, a cap member 15, and a cushion unit 16.

In this embodiment, each of the center channel transducer 11, the surround channel transducer 12 and the mid/woofer transducer 13 is formed integrally with a respective sound enclosure using ultra-thin speaker techniques, which are well known in the art and which will not be described herein for the sake of brevity.

The base plate 14 has a plate body with a first side 1401 and a second side 1402 opposite to the first side 1401. The first side 1401 of the base plate 14 is formed integrally with first, second and third transducer coupling portions 141, 142, 143. Each of the first, second and third transducer coupling portions 141, 142, 143 retains a respective one of the center channel transducer 11, the surround channel transducer 12 and the mid/woofer transducer 13 on the first side 1401 of the base plate 14 such that sound generated by the respective one of the center channel transducer 11, the surround channel transducer 12 and the mid/woofer transducer 13 radiates through the second side 1402 of the base plate 14.

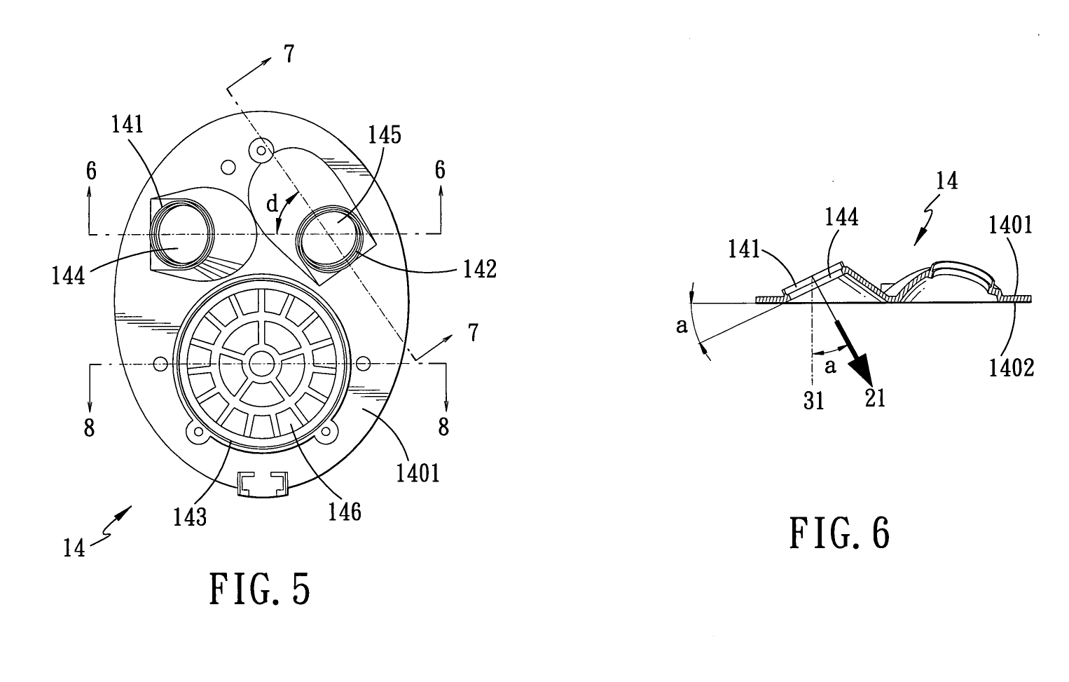

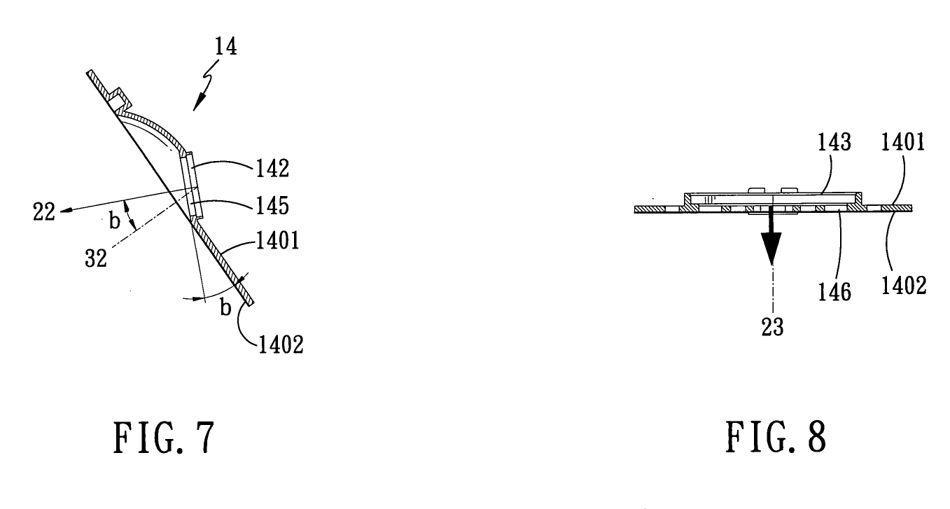

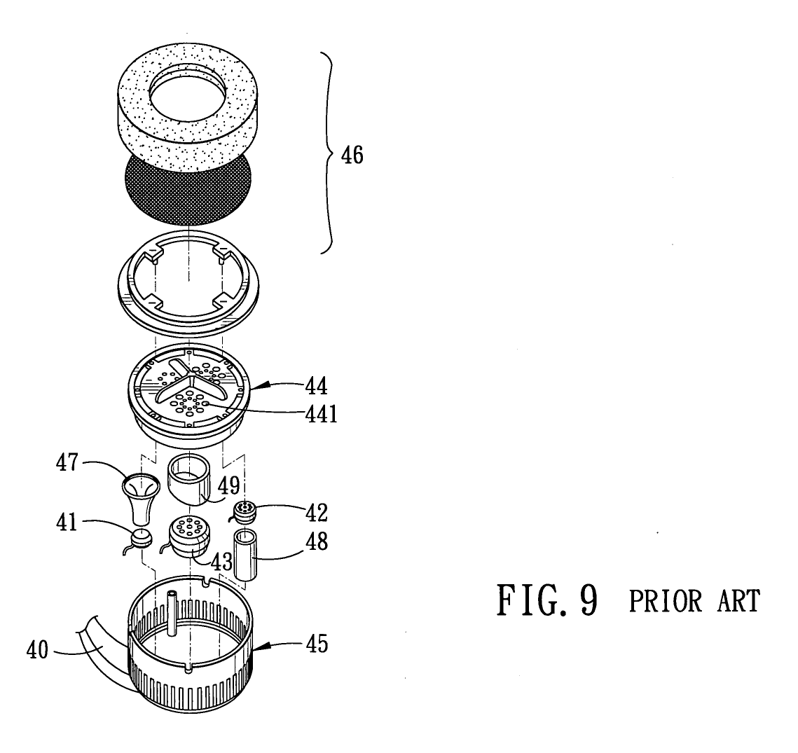

With further reference to FIGS. 5 to 8, the first, second and third transducer coupling portions 141, 142, 143 are hollow portions and have first, second and third axes 21, 22, 23, respectively. The first, second and third axes 21, 22, 23 extend in mutually different directions.

Each of the first and second transducer coupling portions 141, 142 is formed with a respective through hole 144, 145 that extends from the first side 1401 to the second side 1402 of the base plate 14 such that the sound generated by the respective one of the center channel transducer 11 and the surround channel transducer 12 can radiate through the second side 1402 of the base plate 14.

The third transducer coupling portion 143 is formed with a set of through holes 146 extending from the first side 1401 to the second side 1402 of the base plate 14 such that the sound generated by the mid/woofer transducer 13 can radiate through the second side 1402 of the base plate 14.

The cap member 15 is mounted on the base plate 14, and is disposed to conceal the center channel transducer 11, the surround channel transducer 12 and the mid/woofer transducer 13.

Since the first, second and third transducer coupling portions 141, 142, 143 are formed integrally on the base plate 14, the speaker units 10 of the headphone device 1 of this invention have a fewer number of components that results in a relatively simple construction, thereby facilitating assembly and thereby resulting in manufacturing cost savings.

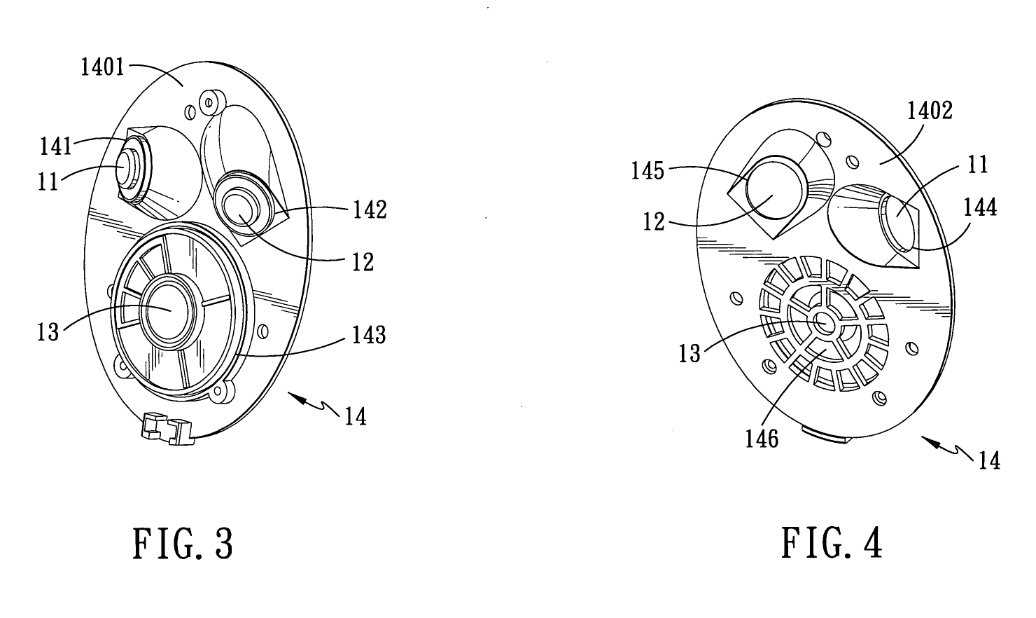

As shown in FIGS. 3, 5 and 6, the first axis 21 forms a first angle (a) with a first line 31 that is transverse to the second side 1402 of the base plate 14. In this embodiment, the first angle (a) ranges from 20 to 30 degrees. As shown in FIGS. 3, 5 and 7, the second axis 22 forms a second angle (b) with a second line 32 that is transverse to the second side 1402 of the base plate 14 and that is spaced apart from the first line 31 (see FIGS. 5 and 6). In this embodiment, the second angle (b) also ranges from 20 to 30 degrees. As evident in FIG. 5, line 6-6 forms a predetermined angle (d) with line 7-7 such that the first and second axes 21, 22 extend in different directions.

As shown in FIGS. 3, 5 and 8, the third axis 23 is transverse to the second side 1402 of the base plate 14.

By designing the first, second and third axes 21, 22, 23 to extend in mutually different directions, an enhanced sound effect can be achieved for the headphone device 1 of the present invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A headphone device with surround sound effect, comprising a speaker unit that includes:
a center channel transducer;
a surround channel transducer;
a mid/woofer transducer; and
a base plate having a first side and a second side opposite to said first side, said first side of said base plate being formed integrally with first, second and third transducer coupling portions,
each of said first, second and third transducer coupling portions retaining a respective one of said center channel transducer, said surround channel transducer and said mid/woofer transducer on said first side of said base plate such that sound generated by the respective one of said center channel transducer, said surround channel transducer and said mid/woofer transducer radiates through said second side of said base plate,
said first, second and third transducer coupling portions having first, second and third axes, respectively,
said first, second and third axes extending in mutually different directions.

2. The headphone device as claimed in claim 1, wherein said speaker unit further includes a cap member mounted on said base plate and disposed to conceal said center channel transducer, said surround channel transducer and said mid/woofer transducer.

3. The headphone device as claimed in claim 1, wherein each of said first and second transducer coupling portions is formed with a through hole that extends from said first side to said second side of said base plate such that the sound generated by the respective one of said center channel transducer and said surround channel transducer can radiate through said second side of said base plate.

4. The headphone device as claimed in claim 1, wherein said third transducer coupling portion is formed with a set of through holes extending from said first side to said second side of said base plate such that the sound generated by said mid/woofer transducer can radiate through said second side of said base plate.

5. The headphone device as claimed in claim 1, wherein said first axis forms a first angle with a first line that is transverse to said second side of said base plate, and said second axis forms a second angle with a second line that is transverse to said second side of said base plate and that is spaced apart from said first line.

6. The headphone device as claimed in claim 5, wherein each of said first and second angles ranges from 20 to 30 degrees.

7. The headphone device as claimed in claim 1, wherein said third axis is transverse to said second side of said base plate.
